(19) United States
(12) Patent Application Publication
(10) Pub. No.: US 2011/0170175 A1
(43) Pub. Date: Jul. 14, 2011

(54) PROCESSING FOR A WINDOW FILM HAVING QUALITY CONCERNS

(75) Inventors: Boon Khee Yeo, Singapore (SG); Aik Kheng Neo, Singapore (SG); Tin Wei Chin, Singapaore (SG)

(73) Assignee: NOVOMATRIX PTE. LTD., Singapore (SG)

(21) Appl. No.: 12/684,810

(22) Filed: Jan. 8, 2010

(51) Int. Cl. G02B 5/20; B32B 37/02

(52) U.S. Cl. 359/359; 156/64

(57) ABSTRACT

In the fabrication of window films which provide solar control or other wavelength selectivity or provide safety and security, any window film which fails to satisfy required visual quality standards for its intended purpose is instead directed to a printing process which enables its use for an alternative purpose. Typically, the original purpose is one of providing uniform optical properties across the window to which the film is applied. The alternative purpose is one in which optical properties are non-uniform, since visible subject matter or patterning is printed on the window film to allow the film to be applied to windows for a decorative, privacy or informative purpose. A particularly suitable method of applying the visible subject matter or patterning is to utilize inkjet printing techniques. A particularly suitable ink is an ultraviolet-curable ink.

### TECHNICAL FIELD

The invention relates generally to window films originally intended for application to windows and relates more particularly to utilization of window films which have been determined to be below the required visual quality standards for their original purpose.

### BACKGROUND ART

Large webs of a flexible transparent substrate material may be surface treated to achieve desired optical properties. For example, a single layer or a sequence of layers may be sputter deposited or metallized onto the web as the substrate material is moved between a first roll and a second roll, with one or more layers being designed to provide solar control or wavelength selectivity. The resulting window film may then be cut into smaller rolls to be shipped to window film dealers, who then divide the rolls into sections having dimensions which match the dimensions of windows to which the window film is to be applied. Window films are commonly applied to windows of automobiles, marine vehicles, residences and commercial buildings.

Typically, the substrate material is polyester. Polyethylene terephthalate (PET) is a suitable substrate material, since it remains flexible at thicknesses which accommodate the surface treatments. A pressure sensitive adhesive may be provided on one side of the substrate. An easily removed liner protects the adhesive until just prior to application of the window film to a window. The surface treatment typically is applied on a side of the substrate opposite to the adhesive. The coated substrate may be laminated to another clear, dyed of metallized

Ideally, the window films which do not satisfy the required visual quality standards would be recycled. However, recycling is typically not cost effective, since the window films contain the pressure sensitive adhesive and, in many instances, the dye and either metal or ceramic coatings. Recycling may require more energy than is conserved by the recycling, since complex processes are needed to filter all of the dye, metal, or ceramic impurities. In addition, all the value-adding costs associated with producing the defective window film, such as any metallization, coating and lamination, would have been wasted. As a result, a considerable amount of defective films which cannot be sold is instead incinerated or buried in landfills. Incineration of the window films results in the release of air pollutants and carbon dioxide, while burial in landfills can result in plastics releasing toxic chemicals into the ground over a long period of time, due to the non-biodegradable nature of window films. A roll of window film may be 5,000 meters in length.

An object of the invention is to provide a handling approach which addresses both environmental and economic concerns when it is determined that a window film does not satisfy required visual quality standards.

### SUMMARY OF THE INVENTION

In accordance with the invention, during the fabrication of window films, any product which fails to satisfy the required visual quality standards for its intended purpose is instead directed to a printing process which enables the “defective” product to be used for an alternative purpose. Visible subject matter or patterning is printed on the window film, so that the film may be applied to windows for a decorative, privacy or advertising purpose. Thus, for a window film that substrate. A hardcoat layer is normally applied to the surface that is exposed, so as to provide scratch resistance under normal cleaning. A non-complex treatment is merely to dye the substrate, but the benefits are limited. Significantly greater benefits are achieved if a more complex coating is applied. The layers of a coating may be metal-based, but other coating materials, such as nano-ceramic layers, can also provide superior performance. Solar energy rejection provided by the window films plays a significant role in reducing energy requirements for heating and cooling the interior of a residence or commercial building. By providing a coating which is designed to block radiation in the infrared and ultraviolet ranges of wavelengths, human skin is better protected and the likelihood of fading of vehicle and home interiors is reduced. In addition to wavelength selectivity, window films may be designed to increase safety, since the window films may reduce the likelihood of shattering when a window is impacted. For example, multi-laminated layers with thicker mounting adhesive may be used to provide an additional level of safety by keeping glass fragments together in the event of accidental breakage.

Prior to the cutting of a web of window film into smaller rolls, visual inspection and testing are performed to determine whether the window film satisfies visual quality standards. Defects of a window film may be a result of introduction of contamination during the fabrication process, crease lines in the substrate material, scratches, or other causes of optical distortion. Since the window films are intended for application to glass windows having a high level of transparency, defects in the window films are usually detected by a person viewing through the combination of window and window film. satisfies the visual quality standards, the intended purpose is to establish acceptable uniform optical properties across the window to which the film is applied. In comparison, for a window film that is determined to have failed to satisfy the required visual quality standards, non-uniformity of optical properties is intentionally achieved by printing visible subject matter or pattering on the film.

In some embodiments, a background is formed prior to the printing of the visible subject matter or pattern. A uniform background is particularly useful for masking highly visible defects, such as film contamination. As one example, a white background may be printed on the window film prior to printing of a decorative pattern or advertisement onto the white background. In another embodiment, the visible subject matter or pattern to be printed is selected on the basis of the particular defects. Thus, pictures may be designed to blend with the defects, such as a straight line theme design being used to print atop a defective film having line creases, such that the line creases are less apparent. In the least complex embodiment, the visible subject matter or pattern to be printed is selected on the basis of its design features that will make the particular defect less visually apparent.

A method in accordance with the invention begins with the fabrication of a window film. As used in this patent document, “window film” is defined as a substrate on which fabrication has been at least partially completed for the purpose of achieving wavelength selectivity and/or safety and security when the substrate is later applied to windows. The fabrication must be sufficiently complete to allow the determination of whether the required visual quality standards will not be met if the fabrication process is completed. Typically, the window film includes a flexible substrate, such as PET. On one side of the substrate a pressure sensitive adhesive and a liner are included in order to accommodate application to windows. On the opposite side of the substrate, at least one layer provides solar control or wavelength selectivity properties, but some embodiments provide a focus on layers with safety and security properties to retain shattered glass when a window is caused to break. Solar control or safety and security may be the goals of window films. In order to protect the window film from scratches and from chemical attack, it is common to include a hardcoat layer following the formation of the layers which provide the solar control or wavelength is selectivity or safety or security.

The visual quality standards may then be applied to the fabricated window film. However, the determination that visual quality standards will not be satisfied may be reached prior to formation of all of the film components, such as prior to the application of the hardcoat layer. If the required visual standards are satisfied, the window films are prepared for application to windows. This may mean the cutting down of the window film into rolls and into appropriately dimensioned segments. However, if the standards are not satisfied, the visible subject matter or patterning is printed onto the window film on the hardcoat layer. As previously noted, a uniform background may be formed prior to the printing of the subject matter or pattern.

Any of a variety of different printing approaches and inks or other print materials may be used. However, different compatibility factors must be considered. Three important factors are ink compatibility, bonding compatibility, and temperature compatibility. The surface energy of the wet ink should be below the surface energy of the material in which the ink is applied, such as the acrylic-based hardcoat layer described above. If the surface energy of the ink is greater than the surface energy of the underlying material, the contact angle of the liquid will be large and the liquid will have a tendency to bead up and form into globules. On the other hand, if the surface energy of the ink is equal to or less than that of the underlying material, the contact angle will be low and the ink will spread evenly across the surface. With respect to bonding compatibility, it is important that the printed subject matter is scratch resistant once applied to the window film. Ink-to-hardcoat bonding compatibility must be considered in the selection of the ink, while required temperatures must be considered in the selection of the method for printing. While PET has a high melting point (approximately 265 degrees C.), its glass transition temperature is relatively low (approximately 70 degrees C.). In order to ensure that the PET does not begin to soften and shrink during the printing process, the process should not require temperatures above the glass transition temperature, so that warping of the window film can be avoided.

One acceptable printing process is to use inkjet print technology. One acceptable print material is ultraviolet (UV) cured ink. Using an UV-cured inkjet printing system can ensure that very low heat is generated in the printing and the curing of the visible subject matter or pattern. Thus, the window film remains intact in terms of its physical properties after the completion of the printing process. UV ink is highly compatible with acrylic-based hardcoats. This results in a high level of scratch-resistance, equivalent to that of the original window film.

### BRIEF DESCRIPTION OF THE DRAWINGS

FIG. 1 is a side view of a representation of components of a window film on which graphics have been printed.

FIG. 2 is a side view of a representation of a second embodiment of the window film on which a blanket background is printed prior to the printing of graphics.

FIG. 3 is a perspective view of the window film of FIG. 1 following attachment to glass.

FIG. 4 is a perspective of the window film of FIG. 2 following attachment to glass.

FIG. 5 is a process flow of steps for forming the window films of FIGS. 1 and 2.

### DETAILED DESCRIPTION

It has been estimated that for a typical manufacturer of window film, the “scrap” rate of defective product is approximately 20% to 30% of the entire window film production. Thus, it is possible that as much as 48 to 72 million square feet of window film is destroyed or dumped on an annual basis across the entire industry. As previously noted, recycling by reducing the defective product into its components is currently not cost effective. Consequently, there is a positive impact on the environment if the defective window film is redirected to a different purpose. In accordance with the invention, a window film which is determined to be defective with respect to accomplishing its original purpose of providing the required optical clarity can be printed upon to provide visible subject matter or patterning that is well suited for the alternative purpose of providing decoration, privacy or providing information (such as advertising information).

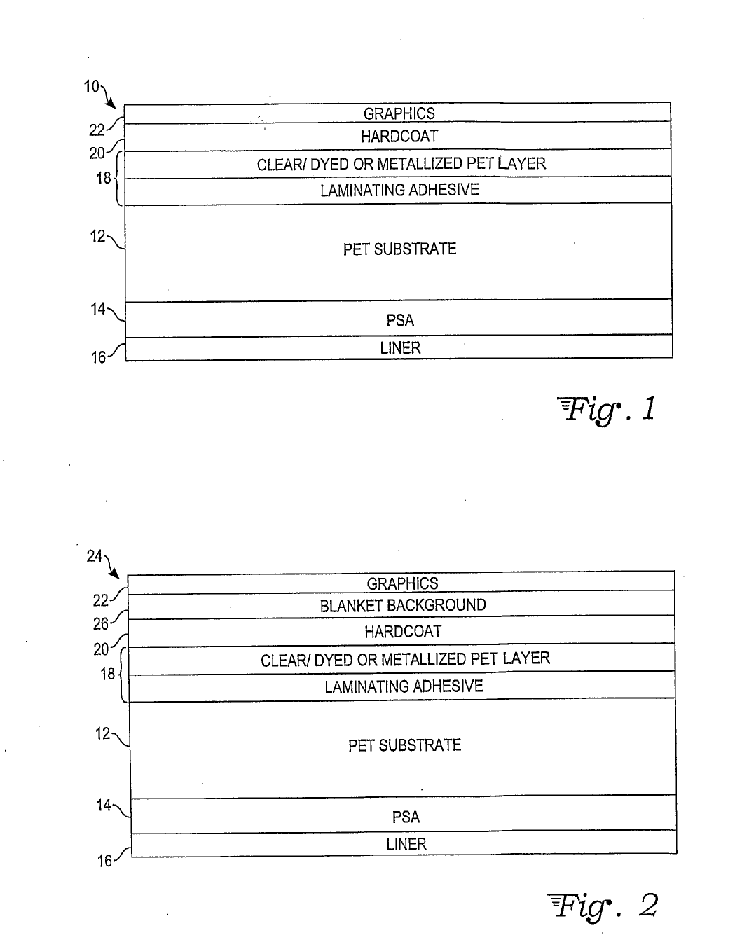

With reference to FIG. 1, a window film 10 in accordance with one embodiment of the invention includes a substrate 12 which supports the other components. The substrate is formed of a flexible material typically used in the industry when fabricating window films. In roll-to-roll processing, polyester-based substrates, such as PET webs, are conventional. A PET substrate having a thickness of between 25 and 100 microns may be used.

In the embodiment shown in FIG. 1, a pressure sensitive adhesive (PSA) is provided on one side of the substrate 12. The PSA is used to attach the window film 10 to a window, such as a vehicle windshield, a window of a residence or commercial building, or a window of a marine vessel. A liner 16, which is also referred to as a release sheet, protects the PSA until immediately prior to application of the window film to the intended window. In the roll-to-roll processing, the large web of window film is divided into appropriately dimensioned segments before the liner is removed and the PSA is brought into contact with the intended window.

On the opposite side of the substrate 12 from the PSA 14 is a single layer or a sequence of layers 18. At least one layer is dedicated to providing solar control or wavelength selectivity. This may include a dyed or metallized layer or a combination of both.

The solar control or wavelength selectivity is preferably provided by a cooperative arrangement of layers. For example, a Fabry-Perot filter may be formed by alternating metal and dielectric layers. Nano-ceramic layers or other metals such as aluminum and nickel chromium may alternatively be used. Significant rejection within the infrared range dramatically lowers cooling requirements. Rejection within the ultraviolet range extends the life span of expensive interior fixtures and furnishings which are subject to fading. As another possibility, safety and security may be a major factor in the application of the invention. It is known to use a layer or multiple layers to reduce the likelihood of glass shattering and/or to retain glass fragments when a window is broken.

Atop the layers 18 is a hardcoat 20. Acrylic hardcoats are often applied to protect the layers 18 from scratching and from chemical attack. As alternatives to an acrylic hardcoat, a silica-based hardcoat, a silozane hardcoat, or a melamine hardcoat may be used. Such materials typically have refractive indices of 1.40 to 1.60, so that the refractive index is generally within the same range as the index of the substrate 12. A conventional thickness range for the hardcoat is 1 micron to 20 microns.

The hardcoat 20 is not critical to window films 10 fabricated for the purpose of providing solar control or safety and security when applied to a window. However, the addition of the hardcoat provides structural benefits to protect the window film against damage from scratches and chemical attack. If the window film satisfies its required visual quality standards, the film is used for its intended purpose. On the other hand, if contamination, scratches, or other defects prevent the window film from being optically acceptable, a determination is made as to whether the film will function for an alternative purpose. That is, rather than being destroyed or buried, the film is redirected with respect to its purpose. Graphics 22 may be printed in order to satisfy a decorative, privacy or advertising purpose. Thus, the defective window film can be applied onto glass that does not require uniform optical properties across its surface.

The window film that comprises the substrate 12, the layers 18 and the hardcoat 20 may already be designed to provide solar control. The addition of the graphics 22 establishes an additional functionality, namely a decorative, privacy or informative functionality. In some embodiments, the graphics are selected on the basis of defects that prevented the window film from satisfying the visual quality standards. For example, pictures may be designed to blend the design with the defects, such as a theme that includes straight lines for printing onto a defective window film having line creases. That is, the theme is selected to hide the imperfections.

FIG. 2 illustrates an embodiment that may be used for applications in which the defects are particularly severe. In the window film 24 of FIG. 2, components that are functionally identical to those of the embodiment of FIG. 1 are given the same reference numerals. The difference in the embodiments is the addition of a blanket background 26. For example, a uniform white background may be printed onto the hardcoat 20 prior to the formation of the graphics 22. Consequently, rather than the window film 10 of FIG. 1, which provides both solar control or wavelength selectivity and a visible functionality, the window film 24 of FIG. 2 provides only the visible functionality.

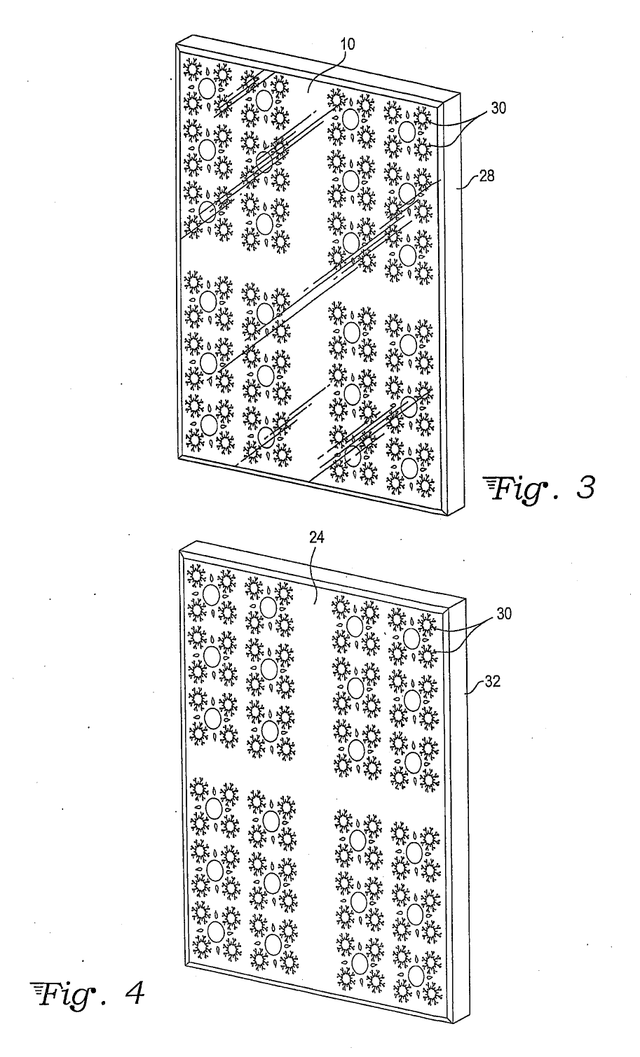

FIG. 3 illustrates the window film 10 of FIG. 1 following application of the window film to a window 28. The combination exhibits a degree of transparency, at least in the areas in which the design features 30 are not printed. The types of decorative themes are relatively limitless.

FIG. 4 is the combination of the window film 24 of FIG. 2 and window 32. However, since the blanket background 26 is included, the combination of window film and glass blocks the passage of light. For both FIG. 3 and FIG. 4, the window films are applied to the glass by removing the liner 16 and contacting the pressure sensitive adhesive 14 to the window.

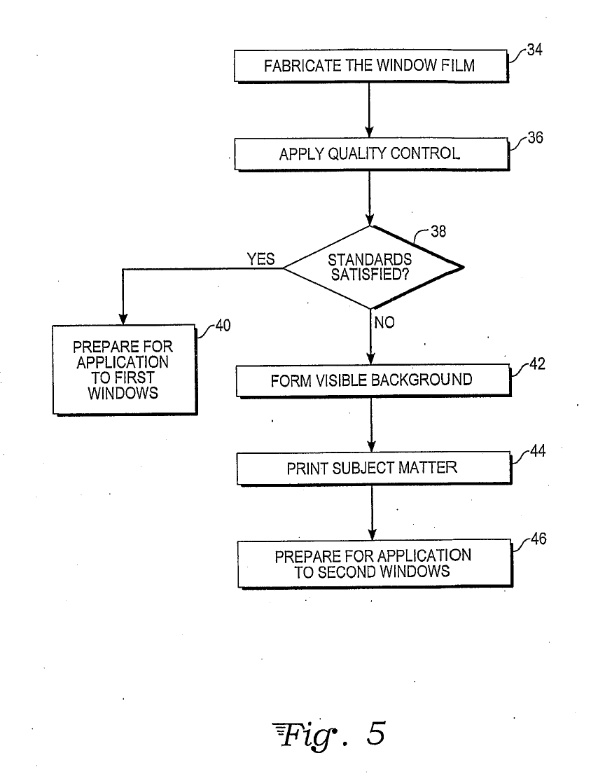

FIG. 5 illustrates one embodiment of the invention. However, as previously noted, the step 42 of forming the background may be eliminated. At step 34, the window film is fabricated. Conventional approaches of fabrication may be utilized, since the original purpose does not include printing graphics onto the window film.

In step 36, the window film is subjected to quality control after the window film has been fabricated. If at decision step 38, it is determined that the window film satisfies the required visual quality standards, the film is prepared for application to “first windows,” which is defined herein as the windows which are consistent with the original purpose for fabricating the film. This preparation may merely be packaging the window film for shipment to other locations for application to windows.

If at decision step 38 it is determined that the visual quality standards are not satisfied, the visible subject matter or patterning is printed at step 44. Dependent upon the defect, the background may be applied at step 42 prior to the printing of the visible subject matter or pattern. This allows the defective window film to be used for its alternative purpose. Then, at step 46, the window film with its additional functionality is prepared for application to “second windows,” which are almost certainly unrelated to the type of “first windows.” As at step 40, the preparation may merely be a packaging arrangement, but the preparation may include dividing the window film into smaller rolls or segments for shipping or for establishing the final dimensions for application to the windows.

It should be noted that steps 36 and 38 may be executed before the window film is fully fabricated. At one or more stages after the start of the fabrication process, it may be determined that visual quality standards will not be met when the process is completed. For example, after the layers have been deposited but before the application of the hardcoat layer, the determination may be reached that the layers include visually detectable defects. In such a situation, the visible graphics or patterning may be printed onto the partially completed window film.

A variety of printing methods and a variety of inks provide acceptable results with respect to establishing the visible background at step 42 and/or the visible subject matter or pattern at step 44. However, at least three compatibility factors must be considered, as previously noted. Three important factors are ink compatibility, bonding compatibility, and temperature compatibility. With respect to ink compatibility, the surface energy of the wet ink should be equal to or less than that of the underlying material, which in FIGS. 1 and 2 is the hardcoat 20. With this relationship of the two surface energies, the ink is more likely to spread evenly across the surface of the underlying material. With respect to bonding compatibility, it is important that the visible subject matter or pattern that is printed remains relatively resistant to scratching and chemical attack. With respect to temperature compatibility, the selection of the printing method is significant. While PET has a relatively high melting temperature, its glass transition temperature is relatively low (approximately 70 degrees C.). In order to ensure that the PET does not begin to soften and shrink during the printing process, the process should not require temperatures above the glass transition temperature.

One acceptable print material is UV-cured ink. One acceptable printing process is inkjet printing. With respect to the ink, the curing takes place through the interaction of the ink ingredients and a strong UV light source. The exposure often takes place in a dryer, which is often referred to as a reactor. An advantage of the UV-cured ink is that little or no solvent is released during the curing process. This is because of the lack of volatile organic compounds (VOCs). The reduction or elimination of VOCs has an appealing environmentally impact. The cross-linking of the UV-cured ink occurs in one to three seconds, depending upon the color of the ink and the intensity of the UV light source. Thus, high-speed production is available. Also, the rapid cure allows the inks to be used in the application of multiple colors in succession without having to move the window film.

Utilizing UV-cured inkjet printing techniques can ensure that very low heat is generated in applying the graphics 22 to the window film. Thus, the required temperature is well below the glass transition temperature of the PET substrate 12 or other polyester-based substrate material. The window film remains intact in terms of its physical properties after the printing process is completed. Moreover, the UV-cured ink is highly compatible with acrylic-based hardcoats 20, thereby ensuring a quality bond between the graphics and the hardcoat. This results in a level of scratch resistance of the graphics that is equivalent to the scratch resistance of the original window film. Additionally, the bonding compatibility reduces the likelihood that the graphics will crack if the window film is installed onto a curved window.

The approach of printing graphics onto rejected window films is an effective way of salvaging window films which do not satisfy required visual quality standards. Because window films contain the pressure sensitive adhesive 14 and in many instances include metal and/or dye coatings, recycling of the defective window films would require significant energy and complex processes to filter out undesired materials. Therefore, defective window films are often destroyed or buried. However, instead of disposing of the rejected window films, which would have a harmful impact on the environment, the present invention provides printing of graphics in order to redirect the window film into a decorative, privacy or informative purpose, such as advertising.

What is claimed is:

1. A method comprising:
fabricating a window film for application to windows for a purpose of solar control or wavelength selectivity or safety and security, including utilizing at least one flexible substrate so as to achieve target properties with respect to said purpose;
determining whether said window film satisfies particular visual quality standards required for said application to said windows; and
printing visible subject matter or patterning on said window film as a specific response to determining that said window film failed to satisfy said visual quality standards, such that said window film is instead available for application to windows for a second purpose.

2. The method of claim 1 further comprising forming a visible background on said window film prior to printing said visible subject matter or patterning, said visible background thereby masking defects responsible for said window film failing to satisfy said visual quality standards.

3. The method of claim 1 further comprising preparing said window film for shipping without printing said visible subject matter or patterning if it is determined that said window film satisfies said visual quality standards, said preparing being a preferred response as compared to printing said visible subject matter or patterning.

4. The method of claim 1 further comprising identifying a basis for a failure of said window film to satisfy said visual quality standards and selecting said visible subject matter or patterning on a basis of masking said failure.

5. The method of claim 1 wherein fabricating said window film includes depositing a solar control or wavelength selectivity coating on a polyester-based web of flexible substrate material or laminating multi-layers of polyester-based substrate material for safety and security.

6. The method of claim 5 wherein said printing includes using inkjet printing techniques to form graphics on a surface of said window film.

7. The method of claim 5 wherein said printing includes depositing ink on a surface of said window film and curing said ink using ultraviolet (UV) radiation.

8. The method of claim 7 wherein fabricating said window film includes forming an acrylic hardcoat as an outermost surface, said printing including using inkjet printing techniques to deposit said ink in a specified pattern onto said outermost hardcoat surface prior to said curing using UV radiation.

9. A method comprising:
providing a web of polyester-based material;
forming at least one layer on said web of polyester-based material to achieve target optical properties when segments of said web are applied to glass windows, said target optical properties including providing solar control or wavelength selectivity or safety and security;
providing protection of said at least one layer by adding a hardcoat such that said at least one layer resides between said flexible substrate and said hardcoat, thereby forming a window film;
applying visual quality control standards to determine whether said window film satisfies required standards;
if said window film satisfies said required standards, preparing said window film for application to first windows to achieve generally uniform optical properties across each said first window; and
if said window film fails to satisfy said required standards, printing graphics on said hardcoat of said window film for application to second windows for which uniform optical properties are less significant.

10. The method of claim 9 further comprising identifying defects which resulted in failure of said window film to satisfy said required visual quality standards and selecting said graphics based upon said defects.

11. The method of claim 9 further comprising forming a blanket background on said hardcoat prior to printing said graphics.

12. The method of claim 9 wherein said hardcoat is an acrylic layer and wherein said printing graphics includes using inkjet techniques.

13. The method of claim 12 wherein said printing graphics further includes using an ink which is cured upon exposure to UV radiation.

14. The method of claim 9 wherein forming said at least one layer includes depositing a single of a sequence of layers specifically designed to provide solar control or wavelength selectivity or safety and security.

15. The method of claim 9 further comprising forming an adhesive on a side of said web opposite to at least one layer.

16. A window assembly comprising:
a window film for application to windows for a purpose of solar control or wavelength selectivity or safety and security, said windows film including at least one transparent flexible substrate and at least one layer for achieving said purpose, said window film having unintended defects which prevent satisfaction of required visual quality standards for said application to said windows; and
printed subject matter or a pattern on an outer surface of said window film for providing human-viewable material such that said window film having said unintended defects is instead available for application to windows for a second purpose.

17. The window assembly of claim 16 wherein said printed subject matter or pattern includes graphics and advertisement.

18. The window assembly of claim 16 further comprising a uniform visible background layer between said printed subject matter or pattern and said at least one layer.

19. The window assembly of claim 16 wherein said at least one layer is a single or sequence of layers selected to achieve solar control or wavelength selectivity or is a multi-layer arrangement to achieve safety and security.
